(19) United States
(12) Patent Application Publication
(10) Pub. No.: US 2016/0011990 A1
(43) Pub. Date: Jan. 14, 2016

(54) System and Method for Conflict-Free Cloud Storage Encryption

(71) Applicant: SAFEND LTD., Tel Aviv (IL)

(72) Inventors: Pavel Berengoltz, Petah-Tikva (IL); Leonid Dorrendorf, Maale Adumim (IL); Leonid Beder, Carmiel (IL)

(21) Appl. No.: 14/770,996

(22) PCT Filed: Feb. 28, 2013
(86) PCT No.: PCT/IL2013/050181

§ 371 Date: Aug. 27, 2015

(51) Int. Cl. G06F 12/14

(52) U.S. Cl. CPC G06F 12/1433; G06F 2212/1052

(57) ABSTRACT

A system and method for conflict-free cloud storage encryption include selecting, from a set of computing devices configured to download data from a shared storage platform, a first device, obtaining, by a first module on the first computing device, a parameter for processing data, selecting, by the first module, a data object stored on the first device and processing the selected data object, using the parameter, to produce a processed data object. The processed data object may be uploaded to the shared storage platform. The parameter may be provided to a second module on a second computing device included in the set and used, by the second module, to reproduce the data object based on the processed data object.

### BACKGROUND OF THE INVENTION

Shared storage platforms and services, e.g., cloud based storage and cloud based file sharing are becoming increasingly popular among enterprises seeking data collaboration and among home users. Shared storage platforms enable data collaboration and backup, file sharing as well as accessing data from any computing device connected to a network. For example, the Dropbox™ service, Box.net™ service and Google Drive™ service are well known in the art.

While enjoying the benefits of cloud storage technology, organizations and users are facing security and privacy concerns as their corporate or private data is uploaded and stored on a public server that is prone to attacks. Although several cloud storage services implement some security measures, an organization using a shared storage platform does not have control over these measures. Moreover, many cloud storage services do not comply with government and/or private sector data protection and retention standards such as Health Insurance Portability And Accountability Act (HIPAA), Sarbanes-Oxley (SOX) and Payment Card Industry Data Security Standard PCI DSS thus affecting the overall security levels of organizations that use cloud storage services.

To protect data, e.g., from unauthorized access due to theft, eavesdropping, or cloud provider negligence, data is typically encrypted. Encryption can be applied at one of several locations, for example: in transit—encryption is performed during transmission over the network, which prevents eavesdropping; at rest—cloud storage providers encrypting the data after it is uploaded to the cloud, preventing data leakage due to negligence or break-ins; and in use—at the user's network endpoint. As known in the art, an endpoint may be any device used by a user to access network services, e.g., a home computer or a smartphone. Encryption at the endpoint has the advantage of naturally protecting the data in transit and in the cloud, as it leaves the endpoint already encrypted. When encryption is applied at the endpoint, end users can choose security implementations and access controls according to their preference.

As cloud storage platforms evolve, challenges other than security also need to be addressed. Shared storage platforms' users are now provided with convenient ways of sharing data (e.g., sharing folders or files). Such features exacerbate the risk of exposing sensitive data to unauthorized parties as well as loss of data consistency, coherency or integrity. Simply applying encryption to shared data may cause issues, such as editing conflicts which occur when multiple copies of the same document are modified independently by two or more users. In addition, applying organizational encryption might lock out external users collaborating with users inside the organization. Accordingly, there is a need in the art for a system and method for conflict-free security for cloud or shared storage platforms.

### SUMMARY OF EMBODIMENTS OF THE INVENTION

A method for conflict-free cloud storage encryption may include selecting, from a set of computing devices configured to download or transfer data from a shared storage platform, a first device and obtaining or receiving, by a first module on the first computing device, a parameter for processing data. The method may include selecting, by the first module, a data object stored on the first device and processing the selected data object, using the parameter, to produce a processed data object and uploading or transferring the processed data object to the shared storage platform. The method may include providing the parameter to a second module on a second computing device included in the set; and using the parameter, by the second module, to reproduce the data object based on the processed data object.

Embodiments of the method may include selecting, from a set of computing devices configured to download data from a shared storage platform, a first computing device to process a data object. For example, a first device in a set may selected as the device that will encrypt a file.

The method may include replacing, by the first module, an unprocessed data object stored in the shared storage platform with the processed data object. The method may include replacing, by the first module, a processed data object stored in the shared storage platform by an unprocessed data object. The method may include selecting the first device based on at least one of: a creator of the data object, a selection by a central server, a property of the first device and a property of the object data. The method may include selecting the data object based on at least one of: a file name, a file type, a storage location, a white list and a black list.

Black and white listings are terms known in the computing industry. Generally, as referred to herein, a black list includes references to one or more data objects that are not to be included in a set of data objects processed. For example, encryption may not be applied to data objects in a black list. A white list may be a list that includes data objects to be processed. For example, only data objects referenced in a white list may be processed, e.g., encrypted. Clearly, usage of a white or black list can be configurable. For example, excluding or including data objects in a set based on a white or black list can be based on a configuration parameter or it can be based on a logic in a unit, module, program or application.

The method may include automatically selecting, by the first module, to process and upload or transfer the data object associated with an application based on at least one of: a metadata file maintained by the application, an operating system configuration parameter associated with the application, an interaction with the application and information obtained from the shared storage platform. The method may include selecting the data object based on determining the data object is shared by at least two computing devices included in the set. The method may include automatically identifying an application that stores data in the shared storage platform and preventing an identified application from uploading data to the shared storage platform. The second module may be downloaded in response to a request to receive the data object. The second module may be configured to check whether permission to access to the data object was revoked and, if so, delete the parameter stored on the second device.

The method may include processing the data object according to a policy received from a remote computing device. The method may include intercepting an attempt to access the data object by an application, and, if the application is associated with the shared storage platform, then providing the processed data object, else, providing the data object. Prior to reproducing the data object, the second module may authenticate a user executing an application attempting to access the data object.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a high level block diagram of a system according to embodiments of the present invention;

FIG. 2 shows a flowchart diagram illustrating a method for conflict-free cloud storage encryption according to some embodiments of the present invention;

FIG. 3 shows a flowchart diagram illustrating a method for conflict-free cloud storage encryption according to some embodiments of the present invention; and

FIG. 4 shows high level block diagram of an exemplary computing device according to embodiments of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory processor-readable storage medium that may store instructions, which when executed by the processor, cause the processor to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

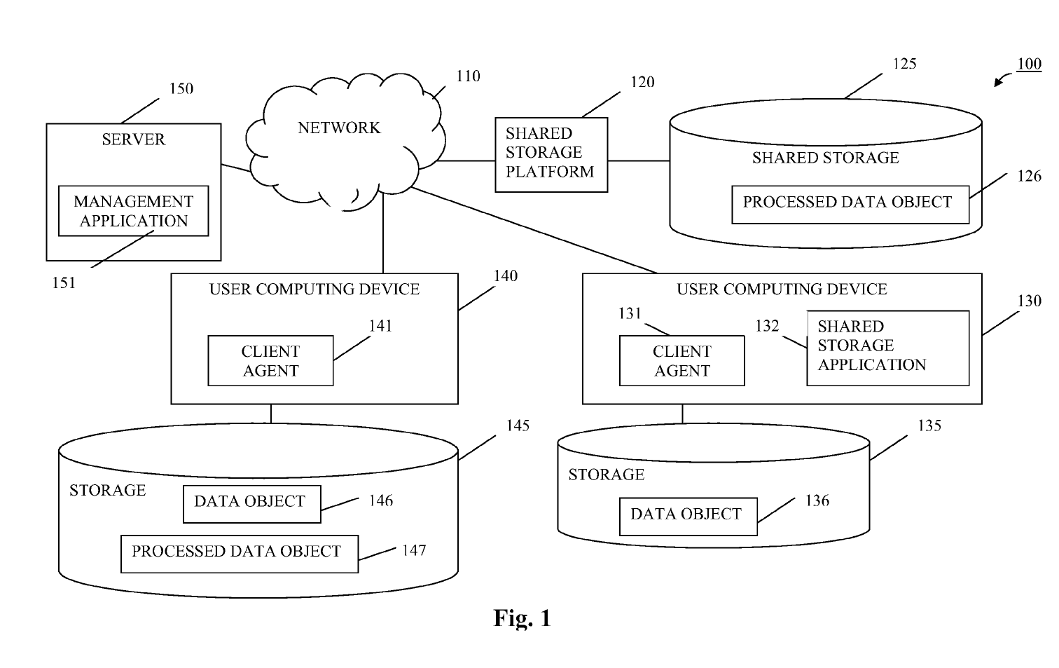

Reference is now made to FIG. 1, which shows a high-level block diagram of a system 100 according to embodiments of the present invention. As shown, system 100 may include a network 110 that may be, may comprise or may be part of, a private or public internet protocol (IP) network, or the internet, or a combination thereof. Additionally or alternatively, network 110 may be, comprise or be part of, a global system for mobile communications (GSM) network. For example, network 110 may include or comprise an IP network such as the internet, a GSM related network and any equipment for bridging or otherwise connecting such networks as known in the art. As shown, system 100 may include a shared storage platform 120. For example, shared storage platform 120 may be one or more servers and applications that provide a shared storage platform such as Dropbox™, Box.net™, or Google Drive™. As shown, shared storage platform 120 may be operatively connected to shared storage 125 where, possibly encrypted or otherwise processed data objects may be stored. For example and as shown, processed data object 126 may be stored on shared storage 125. Shared storage 125 may include or may be any suitable storage system. For example, shared storage 125 may be one or more hard disk drives, a removable or fixed storage unit or it may be a memory installed in a server. In some embodiments, shared storage 125 may be a network storage device and may be geographically distant from shared storage platform 120.

As shown, system 100 may include, or be connected to, a plurality of user computing devices 130 and 140. For the sake of simplicity and clarity, only two user computing devices are shown, however, it will be understood that a system according to embodiments of the invention may include, or be connected to, any (possibly very large) number of user computing devices similar to 130 and 140.

Generally, user computing device 130 may include or may be, for example, a personal computer or a desktop computer, a mobile or laptop computer, a notebook computer and the like. In some embodiments, user computing device 130 may be a network device, a smartphone or a mobile phone or any other suitable computing device capable of at least storing data objects, and communicating over network 110. As shown, user computing device 130 may be operatively connected to storage 135 that may be similar to shared storage 125, e.g., shared storage 125 may be a disk drive connected to a home computer. In other embodiments, e.g., if user computing device 130 is a smartphone, storage 135 may be an internal or add-on memory. User computing device 130 may include components such as, but not limited to, a plurality of central processing units (CPU) or any other suitable multi-purpose or specific processors or controllers, a plurality of input units, a plurality of output units, a plurality of memory units, and a plurality of storage units. For example, user computing device 130, user computing device 140, server 150 and shared storage platform may include components included in device 400 described herein, e.g., controller 405 and memory 420.

User computing device 130 may additionally include other suitable hardware components and/or software components. In an embodiment, user computing device 130 includes client agent 131 that may be a unit, module or application executed by computing device 130. For example, in an embodiment, client agent 131 is a software application executed on computing device 130. In an embodiment, client agents 131 and 141 are modules installed on user devices also referred to herein as endpoints. For example, user computing device 130 is an endpoint in the system shown in FIG. 1. in an organization (e.g., as shown by user computing devices 130 and 140), and communicate with a centralized management application (e.g., management application 151 installed on server 150, or a cloud based management application). For example, client agent 131 and client agent 141 may be implemented or embodied by executable code 425 and controller 405.

An organizational administrator may use the management application to review and control security aspects such as data protection policies. Management application 151 may send to client agents 131 and 141 any command or control data, e.g., a data protection policy parameter such as an encryption key, a file or folder name, a user name and the like. Client agents 131 and 141 may obtain or receive a copy of the data protection policy or other parameters, e.g., encryption keys and may enforce data protection methods, such as file encryption, accordingly.

Some of the devices, methods or embodiments described herein may be similar to respective devices, methods or embodiments described in U.S. Patent Application Publication No. 2012/0246472 published Sep. 27, 2012 and entitled “SYSTEM AND METHOD FOR SECURED BACKUP OF DATA” hereby incorporated by reference in its entirety. For example, computing devices 130 and 140 and server 150 may be similar to respective devices or embodiments described in described in U.S. patent application Ser. No. 13/514,048. Of course, devices and systems as described herein may have other configurations and other sets of components.

Accordingly, computing devices 130 and 140 may selectively provide encrypted or decrypted data, interact with an operating system or other applications, manipulate files or data objects on a storage etc. In addition, familiarity with cloud storage and with security related management and methods, e.g., encryption key management and distribution in an organization is assumed.

User computing device 140 may be similar to computing device 130, storage 145 may be similar to storage 135 and client agent 141 may be similar to client agent 131 as described herein. Server 150 may be any suitable computer and may be used to provide configuration or other parameters to other components of system 100. Management application 151 may be any suitable management application as known in the art. For example, an administrator may use management application 151 to by an administrator to distribute data protection policies to endpoints equipped with client agents that interpret received policies, and apply security measures (e.g., encryption), or otherwise function, based on data received from the management application. Any other management, monitoring or control may be performed by management application 151.

Shared storage application 132 may be a client side application associated with a cloud storage platform, e.g., a desktop application or client as provided by Dropbox™. Data object 136 may be any data object including any type of data. For example, data object 136 may be a file containing text, images and/or multimedia data. For the sake of clarity and simplicity, when discussing data objects, the description herein will mainly refer to files, however, it will be understood that any suitable data object (e.g., a data object stored in a non-transitory memory module) may be used or may be applicable. As described herein, data object 136 may be processed by client agent 131 to produce a processed data object. In a preferred embodiment, processing a data object includes encrypting a data object as known in the art. In some embodiments, processing a data object includes selectively encrypting sensitive or other portions in a data object. For example, processing a file may include selectively encrypting names, amounts, phone numbers or addresses included in the file. A processed data object may be uploaded (e.g., transferred to, possibly via a network) to shared storage 125 by interacting with shared storage platform 120. For example, client agent 131 may determine that shared storage application 132 may upload data object 132 to shared storage 125 and may, prior to such upload, encrypt or otherwise process data object 131. Accordingly, a processed data object may be uploaded to, and stored on, shared storage 125 as shown by processed data object 126.

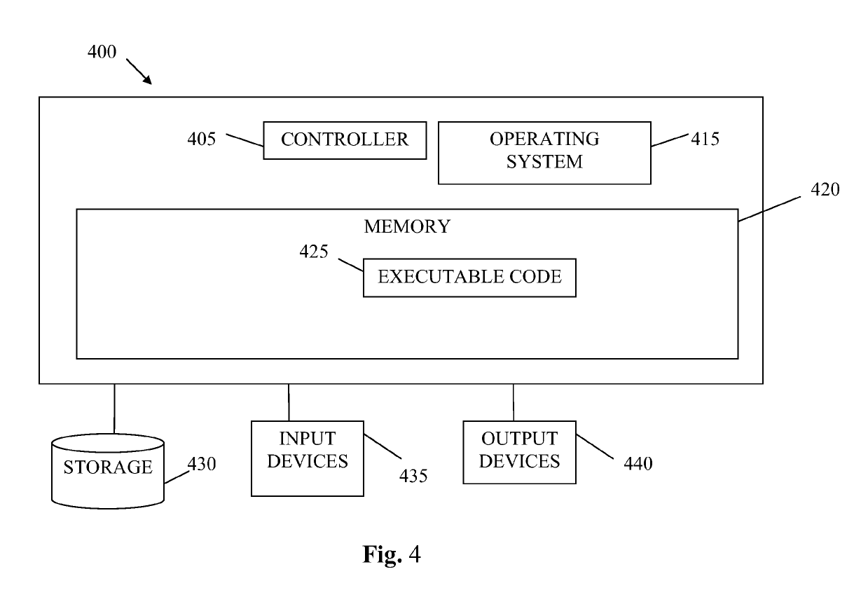

Encrypted or otherwise processed data objects may be downloaded (e.g., transferred, possibly via a network) from shared storage 125 and may be decrypted or otherwise processed such that an unprocessed or decrypted data object is produced. For example, a processed data object 147 may be downloaded to user computing device 140 and stored on storage 145 as shown and may be further processed, e.g., by controller 405 shown in FIG. 4, to produce object data 146 that may be an unprocessed data object. For example, data objects 136 and 146 may be similar, e.g., contain substantially the same data, however, when data included in data objects 136 and 146 is stored on shared storage 125 it may be encrypted, e.g., as shown by processed data object 126. When used herein, uploading and downloading may include for example transferring data between devices, via, e.g., a network.

As described herein, embodiments of the invention enable encrypting files that are saved to cloud storage in a manner that enables sharing and collaboration. Embodiments of the invention enable preventing data conflicts when data is shared and further enable gradual rollout of sharing and encryption across an organization's users, documents or information. Access to shared and/or encrypted data may be dynamically controlled and modified, for example, access rights granted may subsequently be revoked.

Although any suitable shared storage platform may be applicable, embodiments of the invention may particularly applicable to shared storage platforms that provide automatic files and folders synchronization and that include a synchronization client application installed on a client or user computer, e.g., shared storage platforms known in the art such as Dropbox and Google Drive.

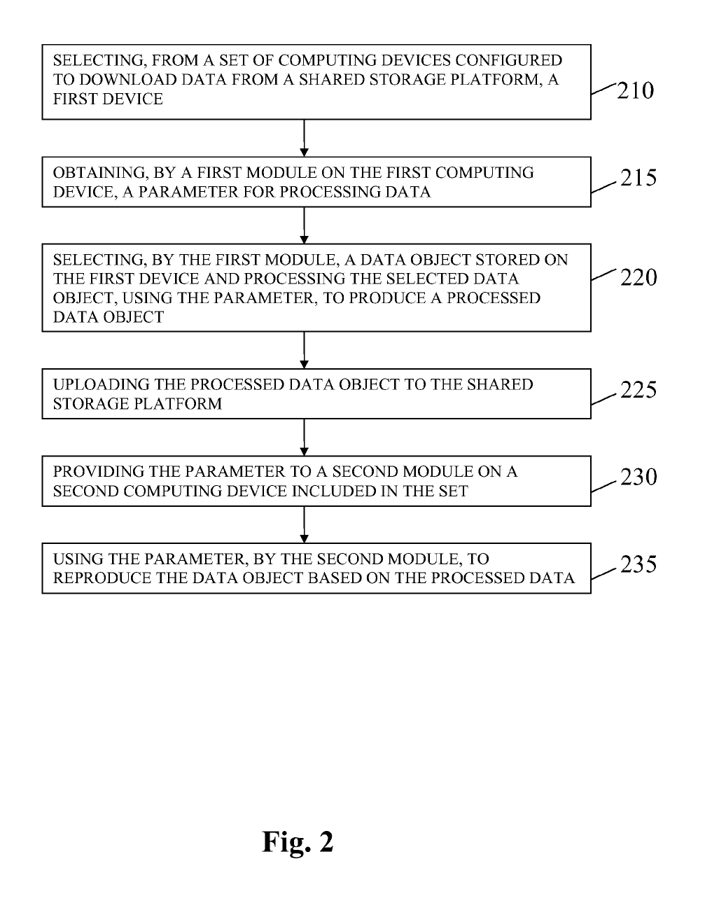

Reference is now made to FIG. 2, a flowchart diagram illustrating a method for conflict-free cloud storage encryption according to some embodiments of the present invention. As shown by block 210, the method or flow may include selecting, from a set of computing devices configured to download data from a shared storage platform, a first device. Selecting a device is further discussed below. For example, user computing device 130 may be selected or designated. For example, controller 405 included in server 150 or included in user computing device 130 may select a first device, e.g., select user computing device 130.

In an embodiment, a device selected is a network endpoint configured to use a shared storage service. To use the shared storage service, the endpoint is configured to upload data to a shared storage (or cloud storage).

Current cloud storage platforms and/or providers resolve conflicts by creating additional or multiple files. For example, when two or more users each locally modify a file and upload a modified version to a shared storage platform, the platform creates multiple (conflicting) files representing the different versions and the conflicts must then be manually resolved. According an embodiment of the invention, conflicts are resolved by designating a single endpoint to perform the task of encrypting and/or uploading a specific file, folder or any set of data objects to a shared storage or a cloud storage.

Determining, selecting or designating the endpoint or device that will act as the encrypting and/or uploading node may be done based on various rules or policies. In the preferred embodiment, a creator of a file is designated as the encrypting and/or uploading entity. For example, if a file is created on user computing device 130 then device 130 is designated as the only endpoint that can encrypt and/or upload the file. In another embodiment, a centralized approach may be employed. For example, in one embodiment, endpoints (e.g., devices such as 130 and 140) communicate with a management application or server (e.g., management application 151 or server 150) over a network and the application executed on the server chooses or designates and endpoint to act as the encrypting or uploading endpoint or device.

In yet another embodiment, a decentralized method for selecting a device from a set of computing devices may be employed. For example, a decentralized distributed system, e.g., as described in “http://en.wikipedia.org/wiki/Distributed_hash_table#Keyspace_partitioning” may be used. In another embodiment, methods as described in Stoica, Ion et al. (2001), “Chord: A Scalable Peer-to-peer Lookup Service for Internet Applications” Proceedings of SIGCOMM'01 (ACM Press New York, N.Y., USA) may be used to determine, select or designate the endpoint or device that will act as the encrypting and/or uploading node.

For example, based on a property of the computing devices (e.g., a media access control (MAC) address) and/or a name of a file to be encrypted or uploaded to a shared storage, the device that will act as the encrypting and uploading entity may be selected or determined. For example, a hash function may associate a file name with a node in an organization. The hash or other function used may be known to all devices in an organization and, accordingly, only one device may be selected to handle a specific file, folder or set of data objects. A device may be selected or determined by an administrator, e.g., using management application 151 on server 150.

As shown by block 215, the method or flow may include receiving or obtaining, by a first module on the first computing device, a parameter for processing data. In the preferred embodiment, client agent 131 receives from management application 151 an encryption key or other information usable to encrypt data object 136.

As shown by block 220, the method or flow may include determining or selecting, by the first module (e.g., an agent, although other modules may be used), a data object stored on the first device and processing the selected data object, using the parameter, to produce a processed data object. In the preferred embodiment, client agent 131 uses an encryption key to process data object 136 and to produce a processed data object.

As shown by block 225, the method or flow may include uploading the processed data object to the shared storage platform. In the preferred embodiment, client agent 131 encrypts data object 136 using an encryption key to produce a processed data object 126 and uploads the processed data object 126 to shared storage platform 120 that stores processed data object 126 on shared storage 125 as shown.

As shown by block 230, the method or flow may include providing the parameter to a second module on a second computing device included in the set. In an embodiment, the encryption key used by client agent 131 to encrypt data object 136 is provided to client agent 141 on user computing device 140. Any method of transferring a key or other parameter from one endpoint to another may be used. In an embodiment, the same management application (e.g., management application 151) that provides a node with a key for a newly created file as described herein also provides the key to other nodes. In other embodiments, e.g., if the encryption key is locally generated (e.g., by client agent 131) then client agent 131 may provide the key to client agent 141 or client agent 131 may provide the key to a central entity (e.g., management application 151) that may, based on a policy or rule, provide the key to agent client 141.

As shown by block 235, the method or flow may include using the parameter, by the second module, to reproduce the data object based on the processed data. For example, in the preferred embodiment, client agent 141 (or another application) downloads processed data object 126 from shared storage platform 120 as shown by processed data object 147, and uses a provided key to decrypt or otherwise process processed data object 147 in order to produce data object 146. Data object 146 may be similar (or even identical in terms of content) to data object 136.

As described herein, embodiments of the invention enable a system and an automated method for encrypting files stored in cloud or shared storage such that sharing of encrypted files is provided, enabling secured teamwork, sharing or collaboration. As described herein, embodiments of the invention enable a system and an automated method for preserving data consistency and/or conflict free shared storage. For example, editing conflicts may be avoided as described herein. Permissions may be dynamically and automatically granted and revoked as follows: A parameter required in order to gain access to encrypted or protected data is provided in order to enable access to data on the device or by a specific user. A parameter required in order to gain access to encrypted or protected data stored on a device may be removed from the device, effectively preventing access to the protected data on the device.

According to embodiments of the invention, an unprocessed data object stored on, at or by, a shared storage platform, may be replaced by a processed data object. For example, an unencrypted document stored at a shared storage platform may be encrypted to produce an encrypted document, the unencrypted document may be removed from the shared storage platform and the encrypted document then is stored on the shared storage platform. In one embodiment, replacing the unencrypted document by the encrypted document includes associating the encrypted document with the same name used for the unencrypted document.

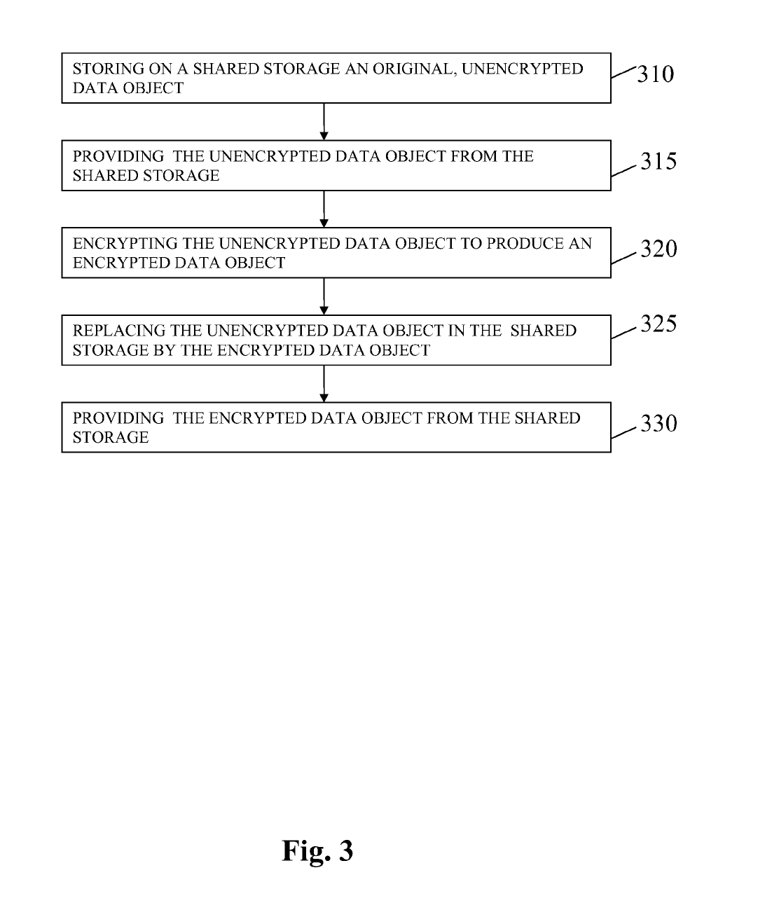

Reference is now made to FIG. 3, a flowchart diagram illustrating a method for conflict-free cloud storage encryption according to some embodiments of the present invention. As shown by block 310, in a preferred embodiment, the method or flow includes storing, on a shared storage, an original, unencrypted data object. For example, shared storage application 132 may upload an un-encrypted file to shared storage 125.

As shown by block 315, the method or flow includes providing the unencrypted data object from the shared storage. For example, an unencrypted file uploaded to shared storage 125 by shared storage application 132 may be provided to user computing device 140.

As shown by block 320, the method or flow includes encrypting the unencrypted data object to produce an encrypted data object. For example, based on an updated policy, client agent 131 may encrypt a file that was previously uploaded (in unencrypted form) to shared storage 125.

As shown by block 325, the method or flow includes replacing the unencrypted data object in the shared storage by the encrypted data object. For example, after encrypting a file as described with respect to block 320, client agent 131 uploads the encrypted file to shared storage 125 thus effectively replacing the unencrypted file in shared storage 125 by the encrypted file. In another embodiment, the task of uploading the encrypted file is left to shared storage application 132.

As shown by block 330, the method or flow includes providing or sending the encrypted data object from the shared storage. For example, following a replacement of an unencrypted file by an encrypted file, shared storage platform 120 will only provide an encrypted file upon request for the file. Accordingly, unencrypted content in a cloud storage may be silently (or in the background) encrypted.

The flow described above may enable changing a policy related to encryption of content so that unencrypted content stored in the cloud is encrypted. In an embodiment, during a first period, a file may be stored on shared storage 125 in its original, unencrypted form. Based on a policy or other consideration, it may be determined that the file needs to be encrypted. In such case, client agent 131 may encrypt the file to produce an encrypted file and replace the original file on shared storage 125 with the encrypted file. Accordingly, encrypting of shared content may be gradual and may be applied to both existing content as well as newly created content. In an embodiment, client agent 131 may encrypt the file and leave the task of uploading the encrypted file to a synchronizing application. For example, in an embodiment, files and folders synchronized by DropBox are encrypted, in their local or original location on user computing device 130 (or on storage 135). Accordingly, embodiments of the invention may silently collaborate with existing applications.

The flows described herein with reference to FIG. 2 and FIG. 3 may be performed by a system. For example, the flows may be performed by system 100 that includes a computing device (e.g., server 150) configured to select, from a set of computing devices configured to download data from a shared storage platform (e.g., user computing device 130 and user computing device 140), a first device (e.g., user computing device 130). In an embodiment, the system includes a first module (e.g., client agent 131) on the first computing device, the first module configured to obtain a parameter for processing a data object, select a data object stored on the first computing device (e.g., data object 136) and process the selected data object, using the parameter, to produce a processed data object. In an embodiment, the first module is configured to transfer the processed data object to the shared storage platform. In an embodiment, the computing device is configured to provide the parameter to a second module (e.g., client agent 131) on a second computing device (e.g., user computing device 140) included in the set and the second module is configured to use the parameter to reproduce the data object based on the processed data object.

According to embodiments of the invention, security measures may be dynamic. For example, in one embodiment, unencrypted shared content is encrypted, and encrypted shared content is decrypted. Accordingly, a content or data object in a shared storage may be encrypted or protected or it may be unprotected (e.g., unencrypted) based on a policy that may change from time to time.

For example, assuming the content in data object 136 and processed data object 126 is the same, based on an updated policy, client agent 131 may replace processed data object 126 by data object 136 such that the content is no longer encrypted or otherwise processed or protected. Client agents 131 and 141 may dynamically force any applicable policy or command, e.g., encrypting or decrypting specific content shared on shared storage 125.

According to embodiments of the invention, any applicable method may be used to select, from a set of devices, a device to obtain or receive a key or other parameter, process a data object and upload a processed data object to a shared storage. As described, by selecting a single device to manipulate, manage or process a data object and/or to upload a data object to a shared storage, conflicts may be avoided. It will be understood that the scope of the invention is not limited by the method used to select a device as described herein. For example, selecting a device may be based on any one of: the creator of the relevant data object, a selection by a central server or management application, a property of the selected device and/or a property of the object data.

For example, in one embodiment, the device on which a file is originally created is automatically selected as the device that will perform encryption and upload of the file. In another embodiment, a central server selects the device, accordingly, even if data object 136 was originally created on user computing device 140, user computing device 130 may be selected (e.g., by an application on server 150) as the device that will encrypt and/or upload the content in data object 136. Any combination of applicable parameters may be used in a device selection process. In another embodiment, a hash (or other) function uniquely and unambiguously associates each file or data object with a single computer in an organization (e.g., using a file name as input and producing a device identification as output). Accordingly, a large number of devices in an organization may run the same function for any data object and may all unambiguously identify the device that will be selected for managing, controlling or supervising a content object.

In an embodiment, the device selected will perform the tasks of encrypting a content object and uploading it to a shared storage platform, removing the content object from the shared storage, replacing an encrypted object in a shared storage with an unencrypted object or replacing an unencrypted object in a shared storage with an encrypted object. Accordingly, a selection of the device may be automatic, centralized or decentralized.

Selection of a device from a set of devices may be based on at least one of: a file name, a file type, a storage location, a white list and a black list. For example, a specific device may be selected for encrypting presentations while another device may be selected to handle text documents. The selection criteria may be provided to some or all devices in an organizations, e.g., by server 150 to agent clients similar to clients 131 and 141. Accordingly, a single device may be selected to handle a specific data object and conflicts may be thus avoided, since no two devices will process the same data object or upload the same data object to a shared storage. Parameters such as a file name, a file type, a storage location or a white or black list may be used to uniquely select the device that will handle encryption or other processing of a data object. Similar parameters may be used to select a device that will upload a data object to a shared storage.

Various methods, rules or criteria may be used in order to select a data object for encryption and/or uploading a processed data object to a shared storage platform. In an embodiment, client agent 131 selects to process a data object based on an association of the data object with a specific application. For example, based on a metadata file maintained by a specific application (e.g., as indicated by an application or user on server 150) client agent 131 may select files for encryption. For example, if DropBox is an application known to synchronize local files with a shared storage then files in folders used by DropBox are encrypted by client agent 131. Accordingly, based on an association with an application, files may be encrypted and uploaded to shared storage. Unencrypted files already stored on a shared storage and associated with an application identified as described may be automatically replaced. For example, client agent 131 may encrypt files that are synchronized by an application and let the synchronizing application upload the encrypted files thus effectively replacing, in the shared storage, unencrypted files with encrypted ones.

For example, based on a configuration parameter, if client agent 131 determines that Google Drive is running or being executed on user computer device 130 then client agent 131 will search for a folder named “Google Drive” under the “My Documents” folder and encrypt files therein. Metadata files associated with an application may be examined in order to locate files to be encrypted. In another example, if a sharing application is known to maintain a list of shared files in a metadata or other file then the relevant file may be examined in order to locate files for encryption. Similarly, configuration parameters related to an application in an operating system may be examined. For example, registry or other constructs of an operating system may be examined in order to locate files for encryption. Shared storage platforms and synchronizing applications may have an application programming interface (API) or a web-based API available to third party application. When an API is available, client agent 131 may interact with an application on device 130, learn from the application where files are stored and encrypt or otherwise manipulate the files as described herein. Accordingly, automatically selecting to process and upload a data object associated with an application may be based on at least one of: a metadata file maintained by the application, an operating system configuration parameter associated with the application, an interaction with the application and information obtained or received from the shared storage platform.

According to embodiments of the invention, an application that stores (or attempts to store) data in a shared storage platform may be automatically identified and may be prevented from storing data in the shared storage platform. For example, in an embodiment, client agent 131 uses standard APIs known in the art to get a list of applications running or being executed on user computing device 130. Based on a list provided management application 151, client agent 131 identifies one or more applications that need to be prevented from storing data in shared storage 125. For example, if an administrator decides that a particular synchronizing or cloud storage application or platform is unsuitable, the administrator provides (through management application 151) an updated black list of applications that includes the unsuitable application. Based on the updated list, client agents 131 and 141 prevent the unsuitable application from storing data on shared storage 125.

A client agent may intercept an attempt, made by an application, to access a data object and, if the application is associated with shared storage platform 120, provide the application with a processed data object instead of the data object. The client agent may selectively provide encrypted or decrypted data objects based on any rule, policy or criteria, e.g., as described in U.S. Patent Application Publication No. 2012/0246472.

For example, in an embodiment, based on a configuration, client 141 provides encrypted data to shared storage application 132 and decrypted data to other applications executing on user computing device 140. In another example, client 141 may (possibly during a first phase), provide encrypted data to applications that upload data to a cloud storage if the data is not shared with other users in the organization. Encrypting data, which is both shared and stored in the cloud, may be performed separately, e.g., by selecting a device to encrypt to encrypt and upload data as described herein.

Selecting to encrypt a data object before it is uploaded to a shared storage platform may be based on whether or not the data object is shared by two or more users or computing devices. For example, a list of applications known to support sharing is used by client agent 131 to determine whether a file or folder is shared. For example, files uploaded by a specific application may all be stored in a known folder. Accordingly, client agent 131 may determine whether a data object is shared by associating the file with an application (e.g., based on the file's location). Accordingly, a system may select to encrypt a data object based on whether or not the data object is shared.

For example, Dropbox™ service stores a special metadata file in every shared folder, accordingly, client agent 131 may examine the metadata files and determine the list of shared folders. Another application, the Box.com™ service, stores a detailed list of shared folders in an operating system's registry. In such case, client agent 131 accesses the registry and extracts file names or other details of shared files. In yet another case, client agent 131 may use a Web API to determine shared files. For example, SkyDrive™ service provides a Web API that can be used by client agent 131 to query shared folders.

Accordingly, a gradual rollout of encryption may be achieved by slowly, over time, and based on a policy or criteria, adding applications, folders or files, user names, or any other information to a list provided to agents similar to client agents 131 and 141 in an organization. By controlling the content of the list, the scope and pace with which encryption of shared data is propagated through an organization may be controlled or managed.

In some embodiments, client agents may be dynamically or automatically installed. For example, client agent 141, or a similar module, may be downloaded to user computing device 140 in response to a request to receive a data object. For example, in order to share processed data object 126, a link may be provided and used, as known in the art, to download client agent 141. A downloaded module (e.g., client agent 141) may verify it is safe or permitted to download processed data object 126 to user computing device 140, and, if so, may download processed data object 126 to user computing device 140. Based on a configuration, downloaded module (e.g., client agent 141) may decrypt or processed data object 126, e.g., in order to reproduce a decrypted version of the content in processed data object 126.

Permission to access a data object may be dynamically changed. For example, permission may be granted and a key for decrypting a processed data object may be provided as described herein. For example, client agent 141 may receive an encryption/decryption key and use the key to decrypt processed data object 147 that may have been downloaded from shared storage 125. Client agent 141 may store the key (or any other received parameter), e.g., on storage 145. Based on a command (or a list described herein) from management application 151, access to processed data object 147 on user computing device 140 may be revoked. To revoke access, client agent 141 may delete the stored key (and, according to the command, possibly decrypted copies of processed data object 147) thus disabling access content in processed data object 147 and effectively revoking a previously granted permission. In other embodiments, client agent 141 may periodically check with management application 151 whether permission to access a file or folder was revoked. Similarly, permission of a user, to access a device or perform a specific action (e.g., view or modify a file's content) may be dynamically granted and revoked.

Permission may be granted or revoked based on any relevant parameter. For example, prior to enabling an application to access a data object, client agent 141 may verify the user executing the application is authorized or otherwise permitted to access the data or content.

For example, prior to reproducing a data object based on a processed data object, client agent 141 may verify the user accessing the data object or any other parameters. For example, client agent 141 may request a password from the user or apply other known in the art security measures, possibly based on data received from management application 151.

With respect to selectively providing either encrypted or decrypted data, file system filtering techniques described in U.S. patent application Ser. No. 13/514,048 may be used to create or provide two different views of files or any data objects in local storage: encrypted and unencrypted. For example, selected applications may be provided with an encrypted view of the data, while other applications are provided with the data in clear, or with decrypted data. For example, a cloud storage synchronization application (e.g., shared storage application 132) may receive an encrypted view, so that any data it sends to the cloud is protected, while all other applications on the same device or system are provided a clear view of the data and can view and/or edit data transparently and without hindrance.

In other embodiments, a file system driver can create and provide different views as described in U.S. patent application Ser. No. 13/514,048. Generally, a file system driver can intercept operations aimed at some set of files and/or directories. For example, an attempt to access files in a specific folder may be intercepted and, rather than providing an un-encrypted file in the folder, an encrypted file may be provided. A file system driver can use file object redirection techniques to create and provide different views of a file, folder or data object. In an embodiment, access to encrypted files is provided transparently. For example, if a user copies or moves a file from an encrypted location, the file may be automatically decrypted. In another case, if a user copies or moves a file from a location of unencrypted files to a location of encrypted files, the copied file is automatically encrypted.

Special or specific files may be handled. Some cloud storage synchronization applications (e.g., shared storage application 132) use metadata files, placed in the synchronized and/or shared folders. Encrypting such files can cause the synchronization application to malfunction. Special files like metadata files used by cloud synchronization applications, as well as other special files designated by a user or an administrator (e.g., in a list described herein), may be exempt from encryption. The files to exempt can be determined using any suitable methods, e.g., a white or black list of file names, extensions, path or a combination of such and other parameters. A registry (for example, some cloud storage applications specify the folders they synchronize and/or share in registry) or a configuration file may be used in order to identify special files or files associated with an application.

An API may all be used in order to identify special files. For example, some cloud storage providers provide a Web API, which any software can use to perform queries and other operations. Web APIs normally allow for enumerating shared files and folders. Accordingly, an API may be used to identify special or other files associated with a cloud or shared storage application or with any application that synchronizes data with a shared or cloud storage.

Various flows or sets of operations may be performed according to embodiments of the invention. In first flow, (a possibly large number of) client agents similar to client agent 131 send to management application 151 a report of cloud storage applications identified on computing devices (e.g., devices 130 and 140) in an organization. The report may include for example lists of folders synchronized with cloud storage, lists of shared folders (synchronized folders accessed by more than one user), and information on files in these folders. Any other information may be included in the report, e.g., information related to users etc.

Using the report, an administrator applies an organizational policy that encrypts files synchronized with a shared or cloud storage. For example, specific files known to be synchronized with cloud storage by a specific application are encrypted. For example, based on a report, the administrator knows which cloud sync applications are active in the organization and can define a policy. For example, based on a policy, only content maintained by a specific cloud service is encrypted. For example, only files synchronized by the Dropbox™ service are encrypted. Since files and folders accessed by the Dropbox™ service are known, client agent 131 can be configured or adapted to only process files accessed by the Dropbox™ service. Based on the active cloud services in an organization, the administrator may define lists of files to be encrypted since the administrator may know which files are typically uploaded to the cloud by each active cloud service. Subsequently, the administrator applies an organizational policy that encrypts files. For example, files in shared synchronized folders are not encrypted, but other synchronized files are encrypted. If one of the users in the organization adds a file to a synchronized folder, the file is encrypted. For example, client agent 131 may monitor specific folders (identified as described herein) and may encrypt any file added to a monitored folder.

In another flow or scenario, a file is shared between two users in the same organization, who have different encryption policy applied. Alternatively, a file is shared between two organizations with different encryption policies applied. In a preferred embodiment, existing files are left unencrypted and new files are encrypted depending on which policy applies to the owner; and any user may select existing files or folders and apply encryption manually. Accordingly, new files can be securely shared and conflicts may be avoided as only one device or user encrypts and uploads the new files.

In yet another flow or scenario, a user in an organization shares an encrypted file or folder with an entity external to the organization. For example, a medical organization sends the results of a medical test to a patient; instead of mailing a compact disk (CD) with the results, the medical organization sends via e-mail a link to a shared folder in cloud storage. The patient receives in the e-mail message a link to software (e.g., a module similar to client agent 131) she can download to view the encrypted content. Accordingly, secured shared storage may be deployed beyond a boundary of an organization.

Access granted by an organization to an external entity (e.g., a subcontractor or collaborator) can be revoked. For example, a subcontractor whose contract expired should lose access to organizational data. Client agent 131 installed on the subcontractor's computer checks periodically (e.g., by communicating with server 150) for revocation, and purges encryption keys needed to view the organizational data previously shared. If needed, client agent 131 or another module may additionally perform tasks typically performed by a Digital Rights Management (DRM) system as known in the art. For example, by including DRM functionality in client agent 131, client agent 131 can prevent an external collaborator from making a copy of the information and transferring it outside a set of protected folders. Accordingly, DRM techniques can be beneficially combined with an embodiment of the invention.

In another case, when a user brings a personal computing device (e.g., a laptop or smartphone) into the organization and wishes to access content in an encrypted or protected folder, shared by the organization using a cloud storage account or platform (e.g., shared storage platform 120). To access the contents of the encrypted folder, the user installs a module unit such as client agent 141 that provides selective access as described herein. The installed module may prompt the user to encrypt additional folders, e.g., folders shared with the organization. In other embodiments, a module may be automatically installed on a user device.

Additional embodiments may combine elements described herein. For example, a module that includes components included in shared storage application 132 and in client agent 131 may be configured to perform tasks described herein. Such module may handle any task handled by shared application 132 and by client agent 131. Accordingly, such module may effectively replace at least shared storage application 132.

A stand alone embodiment may provide access to shared files encrypted previously and/or on another computer. A stand alone application can allow access to encrypted files, while checking permissions and revocation as described herein. The stand alone application can also use one-time access codes generated and sent by a management unit. A stand alone application can effectively serve as a viewer and/or a recovery application.

For example, a medical organization wants to send a document containing medical data to a physician treating a patient. In this case, the document is encrypted and the encrypted document is uploaded to a shared or cloud storage. The organization then sends an e-mail to the physician, the e-mail includes a link usable to download an agent (e.g., client agent 131) which provides access to the encrypted document. The e-mail further includes a one-time access code (password) usable in order to decrypt the encrypted document. In other to enable a one-time access, the downloaded agent deletes the access code (e.g., a decryption key or a password). Accordingly, a sensitive or confidential document can be shared once and the risk of it being further viewed or shared is eliminated. For example, a downloaded agent may display the document (using the encryption key provided online) but may not actually store the document on the target (e.g., physician) computer, thus, a one time view of the document is provided using automatically downloaded agent and code.

Any of the modules, units or client agents described herein may be installed and/or executed on a mobile device, e.g., a smartphone, a laptop or a tablet computer. Any of the modules, units or client agents described herein may include software, firmware or hardware or any combination thereof.

Reference is made to FIG. 4, showing high level block diagram of an exemplary computing device according to embodiments of the present invention. Computing device 400 may include a controller 405 that may be, for example, a central processing unit processor (CPU), a chip or any suitable computing or computational device, an operating system 415, a memory 420, a storage 430, an input devices 435 and an output devices 440.

Operating system 415 may be a commercial operating system. Memory 420 may be or may include, for example, a Random Access Memory (RAM), a Dynamic RAM (DRAM), a Flash memory, or other suitable memory units or storage units. Memory 420 may be or may include a plurality of, possibly different memory units.

Executable code 425 may be any executable code, e.g., an application, a program, a process, task or script. Executable code 425 may be executed by controller 405. For example, executable code 425 may be an application that performs operations described herein with respect to client agents 131 and 141. Executable code 425 may be an application that performs the methods described herein with reference to FIG. 2 and to FIG. 3.

Where applicable, executable code 425 may carry out operations described herein in real-time. Computing device 400 and executable code 425 may be configured to perform methods described herein in real-time. For example, computing device 400 and executable code 425 may update, process and/or act upon information at the same rate the information, or a relevant events, are received.

In some embodiments, more than one computing device 400 may be used. For example, a plurality of computing devices that include components similar to those included in computing device 400 may be connected to a network and used as a system. For example, user computing devices 130 and 140, server 150.

Storage 430 may be or may include, for example, a hard disk drive or other suitable removable and/or fixed storage units. Content may be stored in storage 430 and may be loaded from storage 430 into memory 420 where it may be processed by controller 405. Input devices 435 may be or may include a mouse, a keyboard, a touch screen or pad or any suitable input device. Output devices 440 may include one or more displays, speakers and/or any other suitable output devices.

Any applicable input/output (I/O) devices may be connected to computing device 400 as shown by blocks 435 and 440. For example, a wired or wireless network interface card (NIC), a modem, or external hard drive may be included in input devices 435 and/or output devices 440.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 420, computer-executable instructions such as executable code 425 and a controller such as controller 405.

Some embodiments may be provided in a computer program product that may include a non-transitory machine-readable medium, stored thereon instructions, which may be used to program a computer, or other programmable devices, to perform methods as disclosed herein.

Embodiments of the invention may include an article such as a computer or processor non-transitory readable medium, or a computer or processor non-transitory storage medium including or storing instructions, e.g., computer-executable instructions, which when executed by a processor or controller, carry out methods disclosed herein.

A system according to embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. In some embodiments, a system may include or may be, a personal computer, a desktop computer, a mobile computer, a laptop computer, a notebook computer or any other suitable computing device. Unless explicitly stated, the method embodiments described herein are not constrained to a particular order or sequence. Additionally, some of the described method embodiments or elements thereof can occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method comprising:
selecting, from a set of computing devices configured to download data from a shared storage platform, a first computing device;
obtaining, by a first module on the first computing device, a parameter for processing data;
selecting, by the first module, a data object stored on the first computing device and processing the selected data object, using the parameter, to produce a processed data object;
uploading the processed data object to the shared storage platform;
providing the parameter to a second module on a second computing device included in the set; and
using the parameter, by the second module, to reproduce the data object based on the processed data object.

2. The method of claim 1, comprising replacing, by the first module, an unprocessed data object stored in the shared storage platform with the processed data object.

3. The method of claim 1, comprising replacing, by the first module, a processed data object stored in the shared storage platform by an unprocessed data object.

4. The method of claim 1, wherein selecting the first device is based on at least one of: a creator of the data object, a selection by a central server, a property of the first device and a property of the object data.

5. The method of claim 1, wherein selecting the data object is based on at least one of: a file name, a file type, a storage location, a white list and a black list.

6. The method of claim 1, comprising automatically selecting, by the first module, to process and upload the data object associated with an application based on at least one of: a metadata file maintained by the application, an operating system configuration parameter associated with the application, an interaction with the application and information obtained from the shared storage platform.

7. The method of claim 1, wherein selecting the data object is based on determining the data object is shared by at least two computing devices included in the set.

8. The method of claim 1, comprising automatically identifying an application that stores data in the shared storage platform and preventing the identified application from uploading data to the shared storage platform.

9. The method of claim 1, wherein the second module is downloaded in response to a request to receive the data object.

10. The method of claim 1, wherein the second module is configured to check whether permission to access to the data object was revoked and, if so, delete the parameter stored on the second device.

11. The method of claim 1, comprising processing the data object according to a policy received from a remote computing device.

12. The method of claim 1, comprising intercepting an attempt to access the data object by an application, and, if the application is associated with the shared storage platform, then providing the processed data object, else, providing the data object.

13. The method of claim 1, wherein, prior to reproducing the data object, the second module is to authenticate a user executing an application attempting to access the data object.

14. A method comprising:
selecting, from a set of network endpoints configured to use a shared storage service, a first endpoint to process a data object;
obtaining, by a first module on the first endpoint, a parameter for processing data;
using the parameter, by the first module, to produce a processed data object;
uploading the processed data object using a shared storage using a shared storage service;
providing the parameter to a second module on a second endpoint included in the set; and
using the parameter, by the second module, to reproduce the data object based on the processed data object.

15. The method of claim 14, wherein the second module is downloaded in response to a request to receive the data object.

16. The method of claim 14, comprising replacing, by the first module, an unprocessed data object stored in the shared storage platform with the processed data object.

17. A system comprising:
a computing device configured to select, from a set of computing devices configured to download data from a shared storage platform, a first device; and
a first module on the first computing device configured to:
obtain a parameter for processing a data object,
select a data object stored on the first computing device and process the selected data object, using the parameter, to produce a processed data object, and
transfer the processed data object to the shared storage platform;
wherein the computing device is configured to the provide the parameter to a second module on a second computing device included in the set and wherein the second module configured to use the parameter to reproduce the data object based on the processed data object.

18. The system of claim 17, wherein the first module is configured to replace an unprocessed data object stored in the shared storage platform with the processed data object.

19. The system of claim 17, wherein the first module is configured to replace a processed data object stored in the shared storage platform by an unprocessed data object.

20. The system of claim 17, wherein selecting the first device is based on at least one of: a creator of the data object, a selection by a central server, a property of the first device and a property of the object data.
